(19) United States
(12) Patent Application Publication
(10) Pub. No.: US 2013/0191136 A1
(43) Pub. Date: Jul. 25, 2013

(54) Provider Data Management and Routing

(71) Applicants: Bernie Apshago, Baltimore, MD (US); Lucas Cockerham, Richmond, KY (US); Thomas Fryar, Burlington, KY (US)

(72) Inventors: Bernie Apshago, Baltimore, MD (US); Lucas Cockerham, Richmond, KY (US); Thomas Fryar, Burlington, KY (US)

(73) Assignee: AFFILIATED COMPUTER SYSTEMS, INC., Dallas, TX (US)

(21) Appl. No.: 13/356,329

(22) Filed: Jan. 23, 2012

(51) Int. Cl. G06Q 50/22

(52) U.S. Cl. 705/2

(57) ABSTRACT

A provider data management and routing system comprising a provider data consolidation and routing unit configured to consolidate healthcare provider data for a plurality of payers and to route the consolidated healthcare provider data to the payers, a provider interface coupled to the provider data management and routing unit and configured to forward the healthcare provider data to the provider data management and routing unit, and a plurality of payer interfaces coupled to the provider data management and routing unit and configured to receive the managed and routed healthcare provider data from the provider data consolidation and routing unit.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A healthcare provider is an individual or an institution that provides preventive, curative, promotional, or rehabilitative healthcare services in a systematic way to individuals, families, or communities. Healthcare providers include individuals (also known as health workers), such as healthcare professionals, allied health professionals, community health workers, or other persons trained and knowledgeable in medicine, nursing or other allied health professions, or public/community health. Healthcare providers also include institutions (also known as health facilities), such as hospitals, clinics, primary care centers, and other service delivery points. The practice of health professionals and operation of healthcare institutions is typically regulated by national or state/provincial authorities. Together, they form part of an overall healthcare system.

A healthcare system comprises the organizations that provide healthcare. Configurations of healthcare systems can vary from country to country. However, to function properly, healthcare systems require institutions and facilities, healthcare practitioners and professionals, and financing mechanisms. The healthcare system may be managed and/or funded by governments, or operated completely or partially by private market-based institutions. Market-based healthcare systems rely primarily on individual health insurance from private providers for financing and paying services. Tax-funded systems are those where government makes use of general tax revenue to finance and pay for healthcare.

### SUMMARY

In an embodiment, the disclosure includes a provider data management and routing system comprising a provider data consolidation and routing unit configured to consolidate healthcare provider data for a plurality of payers and to route the consolidated healthcare provider data to the payers, a provider interface coupled to the provider data management and routing unit and configured to forward the healthcare provider data to the provider data management and routing unit, and a plurality of payer interfaces coupled to the provider data management and routing unit and configured to receive the managed and routed healthcare provider data from the provider data consolidation and routing unit.

In another embodiment, the disclosure includes an apparatus comprising a processor configured to receive data from a healthcare provider, implement a consolidated interaction to consolidate the data based on a plurality of local rules and global rules associated with a plurality of payers of the healthcare provider, implement a consolidated outreach to the healthcare provider based on the local rules and global rules associated with the payers of the healthcare provider, receive a response to the consolidated outreach from the healthcare provider, forward the consolidated data and the response to the corresponding payers, and forward the consolidated outreach to the healthcare provider.

In yet another embodiment, the disclosure includes a method for managing and routing healthcare provider data comprising receiving data from one or more healthcare providers that are needed by one or more payer organizations of the healthcare providers, processing the data based on a plurality of local rule and a plurality of global rules both associated with the payer organizations, and providing outreach to the healthcare provider to request missing information in the data, needed documentation, or both according to the local and global rules.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a provider data management and routing system (PDMRS).

FIG. 2 is a schematic diagram of an embodiment of a provider data management flow.

FIG. 3 is a flowchart of an embodiment of a provider data management and routing method.

FIG. 4 is a schematic diagram of an embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Currently, the healthcare industry may use web-based tools to handle healthcare payments, which may not consolidate healthcare industry and payer data rules. For example, when a health provider, such as an individual (e.g., physician or doctor) or an institution (e.g., a hospital), updates its contact data, one or more payers (e.g., a private health insurance company) associated with the health provider may be informed without consolidation and coordination. In some cases, each payer may be informed via phone, email, or a corresponding website (e.g., via Internet). Further, the updated data may be sent to the payer without prior processing or checking for rules that may avoid sending data with errors or in unsuitable format to payers. Typically, the consolidation process is achieved locally, e.g., by a healthcare provider. The provider's data update procedure for payers may be implemented without feedback or outreach to the provider which may be needed for better managing data updates and processing.

Disclosed herein is a provider data management and routing system (PDMRS) and method that may be used to consolidate healthcare provider data for a plurality of associated payers. The PDMRS may handle provider data update, management, and routing to payers in a controlled manner that may include standardized steps. The PDMRS may be configured to receive provider data information from multiple data sources, e.g., multiple providers, and process that information using determined global and/or local rules for handling and processing the information, consolidate the information, and send the processed and consolidated information to the payers. The global/local rules may be a set of industry wide and specific payer rules for provider data management that are specified by or associated with the different payers. The rules may be used to consolidate a plurality of required actions (e.g., for a group of payers) and generate an output for the provider data. Additionally, the PDMRS may be configured to send outreach (or feedback) to the provider, e.g., according to the rules and/or when needed, to request further information or correct some received information. The outreach may also be consolidated outreach that is based on the consolidated healthcare provider data for multiple payers.

The PDMRS may be a software and/or hardware based business decision system configured to receive input data, e.g., from a healthcare provider, and convert that data into a transactional packet, which may be a standardized packet. The transactional packet may be processed by the business decision engine, which may comprise a set of local rules that dictate how data and information transactions are to be handled for a payer. The local rules may also be used to leverage a set of global rules that apply to a plurality of payers. For a payer, the global rules may be applied as needed and then additional local rules corresponding to that payer may be applied. Based on the global and local processing rules, a workflow may be created for the transaction. The workflow may comprise workflow processes (e.g., implemented by software/hardware) and/or manual workflow processes (e.g., implemented by system workers or administrators). When the workflow steps are completed, an output may be created for updating the PDMRS and corresponding payer systems with the relevant provider data. The output may be standardized for each payer.

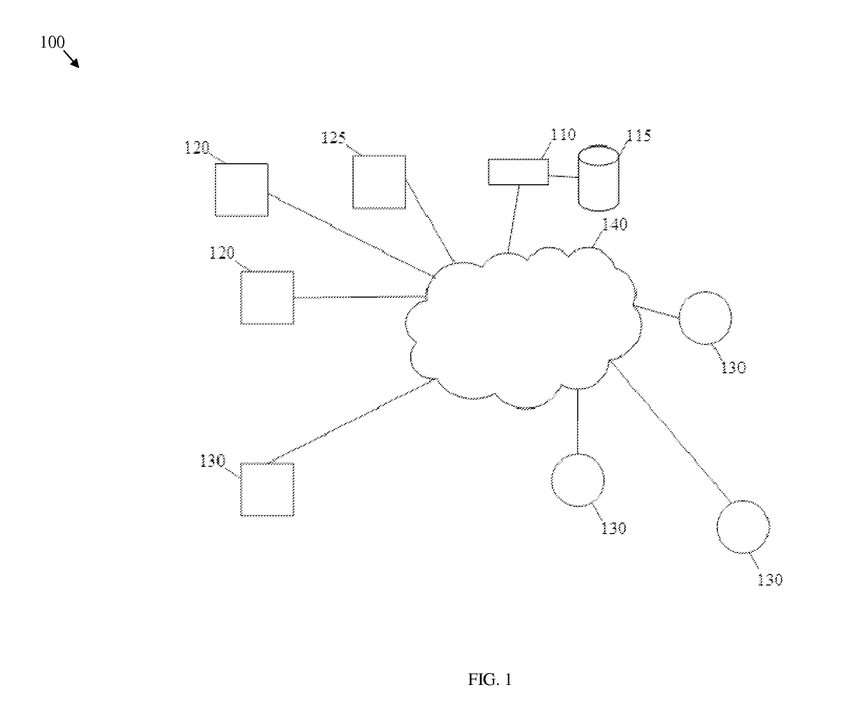

FIG. 1 illustrates an embodiment of a PDMRS 100, which may comprise a provider data management and routing (PDMR) unit 110, one or more providers 120, one or more payers 130, and optionally a network 140 that may be coupled to the remaining components. Additionally, the PDMRS 100 may comprise one or more third parties 125 other than the providers 120 and the payers 130. The components of the PDMRS 100 may be arranged as shown in FIG. 1. The PDMR unit 110 may be configured to receive provider data information from the providers 120, process the information based on a plurality of local and/or global rules of payers 130 for information transactions, consolidate the processed information, and send the information to corresponding payers 130. Similarly, the PDMR unit 110 may receive third party information from the third parties 125, process and consolidate the information, and forward the information to corresponding payers 130. The information sent to the payers may be handled and standardized according to rules for the payer 130 associated with the information. The PDMR unit 110 may also send outreach to the providers 120 and third parties 125, e.g., to request information needed for further processing the provider data, and may receive data from the payers 130.

The PDMRS 100 may be implemented using software, hardware, or both on a processor or computer based system, such as on a server, desktop, laptop, any portable device (e.g., computer tablet or smartphone), or similar devices. In an embodiment, at least parts of the PDMRS 100 may be implemented and maintained on a cloud service (e.g., using the Internet). The PDMRS 100 may be a centralized system implemented using an apparatus or network component or may be a distributed system implemented on a plurality of such devices or systems. The PDMR unit 110 may also comprise or may be coupled to one or more databases 115 that maintain the global/local rules, the provider/third party data, the processed and consolidate information, other information associated with the providers 120, third parties 125, and/or payers 130, other information needed to manage and route data in the PDMRS 100, or combinations thereof. The databases 115 may comprise local databases (e.g., at the PDMR unit 110) and/or remote databases (e.g., at the payers 130, providers 120, third parties 125, and/or network 140).

The providers 120 may comprise a plurality of individuals that provide healthcare services, such as physicians, nurses, physician assistants (PAs), physiotherapists, chiropractors, psychologists, and/or other healthcare practitioners. The providers 120 may also comprise a plurality of institutions or organizations that provide healthcare services, such as hospitals, clinics, primary care centers, pharmacies, healthcare practice centers, drug dispensaries, and/or other health service delivery points. The providers 120 may be clients of the payers 130, which may comprise a plurality of healthcare payment providers that pay the providers 120 for healthcare services offered to registered or subscribed members of the payers 130. For instance, the patients of the providers 120 may be subscribed to healthcare insurance programs offered by the payers 130. The payers 130 may comprise private health insurance companies, public or government supported organizations, or both. The public or government supported organizations may include Medicare, a federal social insurance program for seniors and certain disabled individuals, and Medicaid, State Children's Health Insurance Program (SCHIP), and other public programs, such as provided by TRICARE and the Veterans Health Administration (VHA).

The third parties 125 may comprise a plurality of entities that may be part of the healthcare industry other than the providers 120 and the payers 130, such as vendors of healthcare or medical products, data management systems for the healthcare industry, or other third parties in business or associated with the providers 120/payers 130. The third parties 125 may also be clients of the payers 130 that receive payments from the payers 130 for services provided to subscribers of the payers 130. The subscribers of the third parties 125 may include at least some of the providers 120. For example, a third party 125 may correspond to a vendor of healthcare services or products to a provider 120. Additionally, the providers 120, the third parties 125, and the payers 130 may comprise a plurality of systems, e.g., computerized systems, that may be used to implement appropriate transactions and tasks and to communicate with the PDMR unit 110, e.g., via the network 140. For example, the computerized systems may comprise computer servers, desktops, laptops, any portable devices (e.g., computer tablets or smartphones), or similar devices that may be configured to communicate with the PDMR unit 110.

The network 140 may comprise one or a plurality of communications networks configured to communicate with and allow communications between the PDMR unit 110, the providers 120, the third parties 125, and the payers 130. The network 140 may allow the PDMR unit 110 to receive provider data from the providers 120 and third party data from the third parties 125, and send the data to the corresponding payers 130. The network 140 may also allow the PDMR unit 110 to send requests or data to the providers 120/third parties 125 and allow the payers 130 to send information to the PDMR unit 110. The network 140 may be coupled to the PDMR unit 110, providers 120, third parties 125, and payers 130 via a plurality of corresponding wired and/or wireless links. The network 140 may comprise one or a plurality of access/transport networks that may be based on one or more network transport technologies and protocols. Examples, of the network 140 may include the Internet, Ethernet networks, optical backbone networks, digital subscriber line (DSL) networks, local area networks (LANs), wireless area networks (WANs), other types of telecommunication networks, or combinations thereof.

The provider information, and similarly the third party information, may comprise contact information of a provider (or third party), such as name, address, email, phone number(s), fax number(s), social security number(s), federal tax identifier (ID) or employer ID number (EID), and/or other contact information. The information may also include information about patients, which may be registered members of the payers 130. The information may include new information that is sent to the PDMR unit 110 or updated information that are used to change or update existing information at the PDMR unit 110. The information may also include additional information that is sent to the PDMR unit 110 upon outreach or request.

The PDMRS 100 may reduce the labor required to manage information received from the providers 120/third parties 125 by handling and/or consolidating the information associated with multiple payers 130 based on information transaction rules (local/global rules) for the payers 130. The information transaction rules may be determined or agreed upon by the payers 130 to handle the information from the providers 120 and third parties 125. This PDMRS 100 may also provide a unified tracking scheme (e.g., a common log) for data changes and history of the providers 120/third parties 125, which may be shared with relevant payers 130. The PDMRS 100 or the PDMR unit 110 may also provide a rules engine that determines how to handle data from providers 120 and third parties 125 in a controlled manner. Such rules engine may be lacking in today's implemented healthcare data management systems between payees (providers/third parties) and payers, which may rely substantially on workers and workers' decisions.

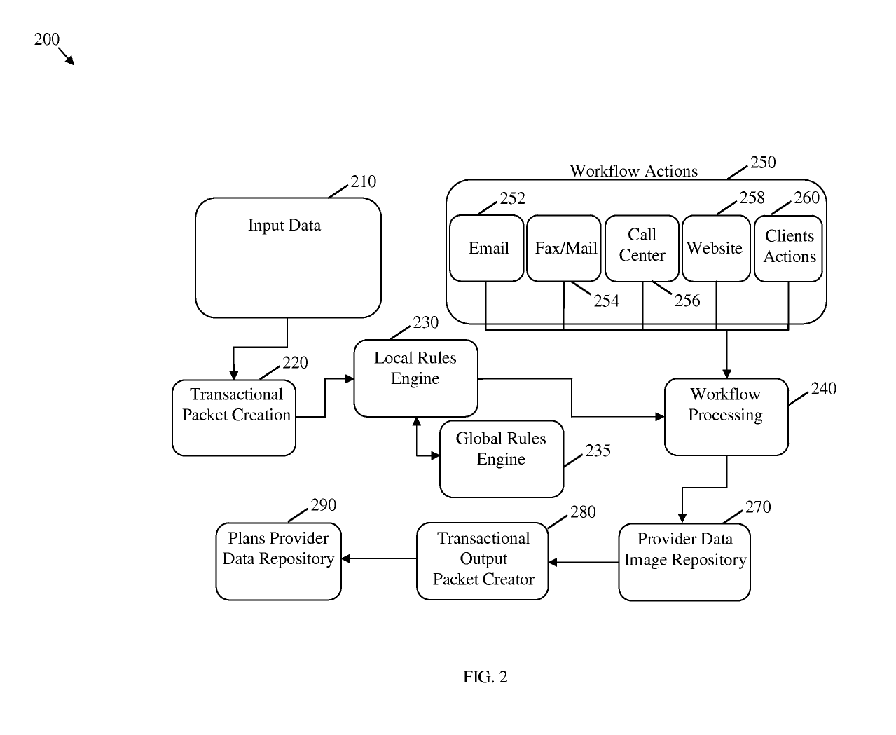

FIG. 2 illustrates an embodiment of a provider data management flow 200 that may be implemented in the PDMRS 100, e.g., between the PDMR unit 110, the providers 120, and the payers 130. The provider data management flow 200 may handle provider information for different payers. A similar flow may also be implemented, e.g., between the PDMR unit 110, the providers 120, and the payers 130, to handle third party data for different payers. The provider data management flow 200 may use a set of global rules that may be applied as needed to a plurality or a broad set of payers. The provider data management flow 200 may also apply a plurality of local rules for corresponding payers. The global/local rules may determine a transaction for provider received data to provide a corresponding output to one or more payers. The provider data management flow 200 may comprise standardized workflow steps and processes.

The provider data management flow 200 may comprise and/or handle a plurality of components and steps, including input data 210, a transactional packet creation step 220, a local rules engine 230, a global rules engine 235, a workflow processing step 240, a plurality of workflow actions 250, a provider data image repository 270, a transactional output packet creator 280, and a plans provider data repository 290. The workflow actions 250 may comprise email action(s) 252, fax/mail action(s) 254, call center action(s) 256, website action(s) 258, client action(s) 260, or combinations thereof.

The input data 210 may be received (e.g., by the PDMR unit 110) from a healthcare provider (e.g., a provider 120). For example, the input data 210 may indicate an updated physical or mailing address for the provider. The input data 210 may be processed at the transactional packet creation step 220 to convert the data into a determined (standard) format or packet, which may be suitable for further processing in the workflow. The data packet may then be processed at the local rules engine 230, where one or more payers (e.g., payers 130) associated with the provider may be identified, and the local rules corresponding to the payers may be used. The local rules may comprise payer specific rules for processing the data packet and determining one or more transactions required for handling the data. The local rules may indicate a correct format for the data in the packet, whether any errors or missing information is needed, and what actions to perform on the data packet. For example, the local rules for a first payer may require including international codes in a provider's phone numbers, while the local rules for a second payer may not have that requirement.

The data packet may also be processed at the global rules engine 235 that may correspond to all or a set of the payers. The global rules may comprise payer common rules for processing the data or packet and determining one or more transactions required for handling the data. The global rules may be based on a common type or group of payers (e.g., public or private payers), a common size of payers (large or small payers), and/or other common features of payers. In an example, the global rules for all payers may require a correct match between a provider's zip code and the provider's city on record. In an embodiment, if conflicts arise between the local rules and the global rules, the local rules may override the global rules in determining the format and transactions for the data or packet. For example, if the local rules indicate formatting the data in the packet in a manner different than indicated by the global rules, then the format indicated by the local rules may be used.

The data packet may then be forwarded to the workflow processing step 240, where one or more transaction may be implemented for handling the data packet, e.g., based on the local/global rules. The workflow processing 240 may also trigger or request one or more workflow actions 250 to handle the packet, including the email action 252, the fax/mail action 254, the call center action 256, the website action 258, and/or the client action(s) 260. For instance, the workflow actions 250 may be triggered or requested when outreach to the provider is needed after implementing the local/global rules (of the payer(s)) and handling the packet at the workflow processing step 240. The workflow actions 250 may be implemented by a machine or a computer, by a worker of the PDMRS, or both.

For instance, if an email to the provider is needed to request additional information or correct received information, then the email action 252 may be implemented by a computer sent email or having a worker type and send the email. If faxing and/or mailing the provider is needed to request this information, then the fax/mail action 254 may be carried out by a worker. If calling the provider is needed for outreach, then the call center action 256 may be implemented. The call may be a pre-recorded call to a provider center or a call made by a worker of the PDMRS at a call center. If requesting the information from a provider website is needed, then the website action 258 may be implemented. For example, a request message may be sent electronically to the website to request information from the provider. The clients action 260 may also be implemented to send a response acknowledging receiving the information (input data) from the healthcare provider, e.g., if required based on the local/global rules. The outreach may be a consolidated outreach that includes one or more of the workflow actions 250 above based on a combination of local/global rules for different payers.

After the workflow processing step 240, the data may be forwarded to the provider data image repository 270, which may be a joint database or comprise separate databases for the payers and providers. The provider data image repository 270 may be owned by the PDMRS 100. The data may then be sent to the transactional output packet creator 280, which may be configured to convert the processed data packet into a suitable output data packet format. For instance, the output data format may depend on the communications or networking technology used to send the packet to the payer(s), such as an Ethernet packet, an Internet Protocol (IP) packet, or other types of packets. The output data may then be forwarded to a plans provider data repository 290, which may be a database associated with one or more payers.

In an example of the provider data management flow 200, an address update or change may be received from a provider associated with one or more payers. The local rules engine 230 may determine whether the address change for a corresponding payer requires a different business action than a global policy for all or multiple payers (as indicated by the global rules engine 235). If the address change for the payer requires a different action than the global policy, then the local rules engine 230 may generate the workflow requirements for handling the corresponding action. For example, a first payer for the provider may require an effective date for an address change and a second payer for the provider may require an address change and sending the address change request on a letterhead from the provider's office. The local/global rules may also indicate that an outreach is required. As such, the workflow may be a consolidated outreach that includes sending an email notification (e.g., based on the set of rules) to the provider to ask the provider to both respond with the request for address change on a letterhead and to include the effective date in the request. The consolidated outreach communications with the provider may also indicate to that provider that the address change would be sent to the first payer and the second payer and that the payers' records would be updated. The workflow may wait for the returned communications from the provider, and after receiving the information may update the payers' records or databases, e.g., locally, and then send the information to the payers that require the updated information.

The PDMRS and workflow described above may be used to consolidate provider data update activities that may be repeated for multiple payer organizations. Consolidating the provider data update activities for multiple payers may save the cost of handling, managing, processing, and/or routing the data. For example, when a provider changes address or other provider information, the provider may need to or may be required to send the update to several payers and include various types of supporting documentation. The update activities may be consolidated in the PDMRS using a workflow or an interaction (e.g., implemented by a PDMR unit), as described above. The PDMRS or PDMR unit may then send the consolidated data package to the corresponding payer organizations, thus reducing the need for each organization to collect this information independently. The PDMR service may be provided to payer organizations by a party (e.g., a company or an organization) that is separate from the providers and payers.

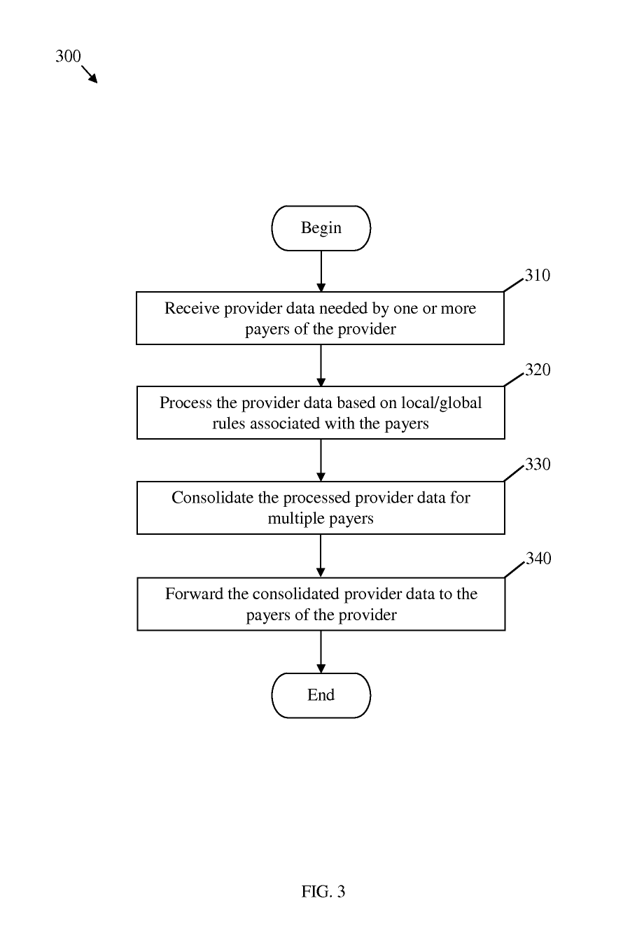

FIG. 3 illustrates an embodiment of a provider data management and routing method 300 that may be implemented in the PDMRS 100, e.g., by the PDMR unit 110. The provider data management and routing method 300 may be implemented to receive provider data information from one or more providers (e.g., providers 120), process the information based on a plurality of local and/or global rules for information transactions, consolidate the processed information for a plurality of payers, and send the information to corresponding payers (e.g., payers 130). The method 300 may begin at block 310, where provider data needed by one or more payers of the provider may be received. The provider data may be sent from the provider to the PDMRS or PDMR unit and may include new or updated provider information that may be needed on record by the provider's payers. At block 320, the provider data may be processed based on local/global rules associated with the payers. The processing may comprise a workflow or a transaction that may be determined by the local/global rules, including one or more actions or activities for handling the provider data. The actions and activities may comprise performing outreach to the provider, such as in the case of errors or missing information. The processing may also comprise converting the provider data, e.g., into a determined data packet format, that may be suitable for the workflow or interaction activities.

At block 330, the processed provider data may be consolidated for multiple payers. The consolidation process may include combining the different information and/or documentation needed for multiple providers into a common data package and updating one or more local records or databases for the providers at the PDMRS. The consolidation process may also comprise converting the processed provider data into a common and suitable output format (e.g., data packet) for the providers. At block 340, the consolidated provider data may be forwarded to the payers of the provider. The information may be forwarded as determined by the local/global rules, such as using email actions, fax/mail actions, or other actions for communicating with the payers. The method 300 may then end. Similarly, the method 300 may be implemented to receive information that is needed by the payers from a third party, such as a vendor or a data management system, process the third party's information based on rules of the payers, consolidate the information for multiple payers, and forward the processed and consolidated information to the payers.

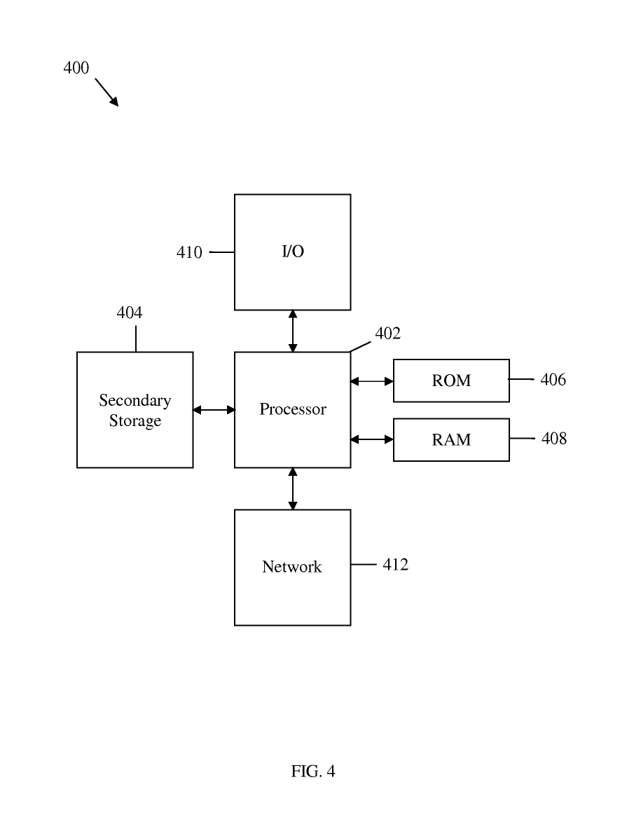

The components described above may be implemented on any general-purpose network component, such as a computer or network component with sufficient processing power, memory resources, and network throughput capability to handle the necessary workload placed upon it. FIG. 4 illustrates a typical, general-purpose network component 400 suitable for implementing one or more embodiments of the components disclosed herein. The network component 400 includes a processor 402 (e.g., a central processing unit (CPU)) that is in communication with memory devices including secondary storage 404, read only memory (ROM) 406, random access memory (RAM) 408, input/output (I/O) devices 410, and network connectivity devices 412. The processor 402 may be implemented as one or more central processing unit (CPU) chips, or may be part of one or more application specific integrated circuits (ASICs) and/or digital signal processors (DSPs).

The secondary storage 404 is typically comprised of one or more disk drives or tape drives and is used for non-volatile storage of data and as an over-flow data storage device if RAM 408 is not large enough to hold all working data. Secondary storage 404 may be used to store programs that are loaded into RAM 408 when such programs are selected for execution. The ROM 406 is used to store instructions and perhaps data that are read during program execution. ROM 406 is a non-volatile memory device that typically has a small memory capacity relative to the larger memory capacity of secondary storage 404. The RAM 408 is used to store volatile data and perhaps to store instructions. Access to both ROM 406 and RAM 408 is typically faster than to second storage 404.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A provider data management and routing system comprising:
a provider data consolidation and routing unit configured to consolidate healthcare provider data for a plurality of payers and to route the consolidated healthcare provider data to the payers;
a provider interface coupled to the provider data management and routing unit and configured to forward the healthcare provider data to the provider data management and routing unit; and
a plurality of payer interfaces coupled to the provider data management and routing unit and configured to receive the managed and routed healthcare provider data from the provider data consolidation and routing unit.

2. The provider data management and routing system of claim 1, wherein the provider data consolidation and routing unit is further configured to provide consolidated outreach to a provider via the provider interface to request healthcare provider data.

3. The provider data management and routing system of claim 1, wherein the provider data consolidation and routing unit comprises a local rules engine configured to maintain a plurality of local rules associated with corresponding payers, and wherein the local rules are used to determine a workflow for handling the healthcare provider data and to provide outreach to a provider.

4. The provider data management and routing system of claim 1, wherein the provider data consolidation and routing unit comprises a global rules engine configured to maintain a plurality of common global rules associated with at least some of the payers, and wherein the common global rules are used to determine a workflow for handling the healthcare provider data and to provide outreach to a provider.

5. The provider data management and routing system of claim 1 further comprising a communications network coupled to the provider data consolidation and routing unit, the provider interface, and the payer interfaces and configured to allow communications and exchange of healthcare provider data between the provider data management and routing unit, the provider interface, and the payers interfaces.

6. An apparatus comprising a processor configured to:
receive data from a healthcare provider;
implement a consolidated interaction to consolidate the data based on a plurality of local rules and global rules associated with a plurality of payers of the healthcare provider;
implement a consolidated outreach to the healthcare provider based on the local rules and global rules associated with the payers of the healthcare provider;
receive a response to the consolidated outreach from the healthcare provider;
forward the consolidated data and the response to the corresponding payers; and
forward the consolidated outreach to the healthcare provider.

7. The apparatus of claim 6, wherein the consolidated interaction comprises a plurality of workflow actions that comprise at least one of an email action, a mail action, a fax action, a call center action, a website action, and a response action.

8. The apparatus of claim 7, wherein the workflow actions are implemented to forward the consolidated data to the payers, provide consolidated outreach to the healthcare provider, or both, and wherein the workflow actions are implemented electronically, by a worker, or both.

9. The apparatus of claim 6, wherein the consolidated interaction comprises converting the received data into a transactional packet and processing the transaction packet based on the local rules and global rules associated with the payers to obtain an output transaction packet comprising the consolidated data.

10. The apparatus of claim 6, wherein the consolidated data comprise new information about the healthcare provider that are needed by the payers, updated information about the healthcare provider that are needed by the payers, or both.

11. The apparatus of claim 6, wherein the consolidated data comprise address information, telephone number information, tax number information about the healthcare provider, or combinations thereof.

12. The apparatus of claim 6, wherein the local rules comprise different requirements for different payers, and wherein the requirements determine format, documentation, or both for the received data from the healthcare provider.

13. The apparatus of claim 6, wherein the global rules comprise common requirements for different payers, and wherein the requirements determine format, documentation, or both for the received data from the healthcare provider.

14. A method for managing and routing healthcare provider data comprising:
receiving data from one or more healthcare providers that are needed by one or more payer organizations of the healthcare providers;
processing the data based on a plurality of local rule and a plurality of global rules both associated with the payer organizations; and
providing consolidated outreach to the healthcare provider to request missing information in the data, needed documentation, or both according to the local and global rules.

15. The method of claim 14 further comprising providing outreach to the healthcare provider to request more information if there is an error in the received data.

16. The method of claim 14, wherein the consolidated outreach comprises sending an email notification to the healthcare provider to ask from the healthcare provider to both respond with an address change request on a letterhead and include an effective date in the address change request, and wherein the consolidated outreach also indicates to the healthcare provider that the address change request will be sent to a first payer and a second payer and that the payers' records will be updated.

17. The method of claim 14 further comprising:
consolidating the processed data for the payers; and
forwarding the consolidated data to the payers.

18. The method of claim 17, wherein processing and consolidating the data comprises converting the received data into a determined input packet format suitable for processing and converting the data into a determined output packet format suitable for forwarding the data.

19. The method of claim 17, wherein processing and consolidating the data comprises implementing a workflow of a plurality of actions according to the local and global rules.

20. The method of claim 17, wherein processing and consolidating the data comprises maintaining the data into one or more local information repositories corresponding to the payers.
